(19) United States
(12) Patent Application Publication
(10) Pub. No.: US 2024/0242163 A1
(43) Pub. Date: Jul. 18, 2024

(54) INFORMATION PROCESSING METHOD, INFORMATION PROCESSING APPARATUS, AND NON-TRANSITORY COMPUTER READABLE RECORDING MEDIUM

(71) Applicant: Panasonic Intellectual Property Corporation of America, Torrance, CA (US)

(72) Inventors: Yasuyuki YAMAGA, Kanagawa (JP); Ryo AIDA, Kanagawa (JP); Yuki WATANABE, Kanagawa (JP); Takeshi NONAKA, Chiba (JP)

(73) Assignee: Panasonic Intellectual Property Corporation of America, Torrance, CA (US)

(21) Appl. No.: 18/587,503

(22) Filed: Feb. 26, 2024

Related U.S. Application Data
(63) Continuation of application No. PCT/JP2022/013911, filed on Mar. 24, 2022.

(30) Foreign Application Priority Data
Aug. 30, 2021 (JP) 2021-140029

(51) Int. Cl. G06Q 10/0639

(52) U.S. Cl. CPC G06Q 10/06398

(57) ABSTRACT

An information processing apparatus outputs on the basis of an evaluation value for a first worker confirmation information of ordering a first worker to perform a confirmation as to whether a first operation is normally completed, the confirmation information including more confirmation items as the evaluation value is lower; determines on the basis of confirmation result information indicative of a result of the confirmation whether the first operation is normally completed; determines, when the first operation is determined to be not normally completed, on the basis of the confirmation result information whether a cause due to which the first operation is not normally completed lies in a second operation by a second worker different from the first operation; and decreases an evaluation value for the second worker when the cause is determined to lie in the second operation.

### FIELD OF INVENTION

The present disclosure relates to a technique of assisting an operation for a device.

### BACKGROUND ART

Patent Literature 1 discloses a technique for obtaining exact actual working time for a worker of: displaying on a display device a work permit for a work package that is a work unit for building a constructive object; registering one or more workers for the work package; acquiring working time information on the time required to complete the work package; and generating work record information including identification information on the work package and the working time information.

However, Patent Literature 1 merely discloses obtaining of an exact working time for a work package, where an additional confirming operation (hereinafter, referred to as additional confirmation) cannot be imposed on a worker with a low work evaluation. Thus, there is room for further improvement.

Patent Literature 1: International Unexamined Patent Publication WO 2021/064877

### SUMMARY OF THE INVENTION

The present disclosure has been made to solve the above-mentioned problem, and an object thereof is to provide a configuration of imposing an additional confirmation on a worker with a low evaluation.

An information processing method according to an aspect of the present disclosure, by a processor of an information processing apparatus, includes: acquiring, when detecting completion of a first operation by a first worker, an evaluation value for the first worker; outputting on the basis of the evaluation value confirmation information of ordering the first worker to perform a confirmation as to whether the first operation is normally completed, the confirmation information including more confirmation items as the evaluation value is lower; determining on the basis of confirmation result information indicative of a result of the confirmation whether the first operation is normally completed; determining, when the first operation is determined to be not normally completed, on the basis of the confirmation result information whether a cause due to which the first operation is not normally completed lies in a second operation by a second worker different from the first operation; and decreasing an evaluation value for the second worker when the cause is determined to lie in the second operation.

The present disclosure enables provision of a configuration of imposing an additional confirmation on a worker with a low evaluation.

### BRIEF DESCRIPTION OF THE DRAWINGS

FIG. 1 is a block diagram showing an exemplary whole structure of an information processing system according to an embodiment of the present disclosure.

FIG. 2 is an illustration showing exemplary operations in the present embodiment.

FIG. 3 is a block diagram showing an exemplary structure of an information processing apparatus according to the embodiment of the present disclosure.

FIG. 4 is a table showing exemplary data components in an assist database.

FIG. 5 is a table showing exemplary data components in a confirmation information database.

FIG. 6 is a flowchart showing an exemplary process of the information processing apparatus according to the embodiment of the present disclosure.

FIG. 7 is a flowchart showing steps of a determination process in Step S4 shown in FIG. 6.

### DETAILED DESCRIPTION

### Underlying Findings for Present Disclosure

For example, there is a case that work of installing an IoT device is performed by an installation company after completion of construction work of preparing a communication environment by a construction company in a building such as a house. The construction work includes, for example, an operation of connecting a communication connector to an end of a communication cable and an operation of placing a communication cable in a wall of the building. The installation work includes, for example, an operation of physically connecting an IoT device with the placed communication cable and an operation of entering a setting necessary to connect the IoT device to a network.

In the construction work, there may be a failure in connection of a communication connector to a communication cable accurately, or a failure in placement of a communication cable accurately. Such failures hinder the installation company that starts an operation on the working site after the completion of the construction work from connecting an IoT device to a network and normally completing the installation work. In this case, there are problems that the installation company must determine whether the cause of the failure in the connection of the IoT device to the network lies in the installation company or the construction company; call the construction company to the working site when the cause lies in the construction company; or overcome by itself the failures of the communication cable, which are burdensome for the installation company.

To prevent such problems, a configuration is useful that makes the installation company evaluate the construction company and imposes an additional confirmation on the construction company according to the evaluation. Specifically, a configuration is useful that, in a case that a worker cannot complete their operation due to a failure in another operation by another worker, makes the worker of the operation evaluate the other worker and imposes an additional confirmation on the other worker according to the evaluation.

Thus, the present disclosure provides the following configurations.

An information processing method according to an aspect of the present disclosure, by a processor of an information processing apparatus, includes: acquiring, when detecting completion of a first operation by a first worker, an evaluation value for the first worker; outputting on the basis of the evaluation value confirmation information of ordering the first worker to perform a confirmation as to whether the first operation is normally completed, the confirmation information including more confirmation items as the evaluation value is lower; determining on the basis of confirmation result information indicative of a result of the confirmation whether the first operation is normally completed; determining, when the first operation is determined to be not normally completed, on the basis of the confirmation result information whether a cause due to which the first operation is not normally completed lies in a second operation by a second worker different from the first operation; and decreasing the evaluation value for the second worker when the cause is determined to lie in the second operation.

In this configuration, when the first operation is determined to be not normally completed, it is determined on the basis of the confirmation result information whether the cause lies in the second operation by the second worker, and, when the cause is determined to lie in the second operation, the evaluation value for the second worker is decreased. This makes the second worker have more confirmation items when the second worker performs the operation next time. Thus, provision of the configuration of imposing an additional confirmation on a worker that has performed an imperfect operation can be achieved.

In the information processing method, the confirmation information may have one or more confirmation items each of which is associated with a worker responsible for the confirmation in advance.

In this configuration, since the confirmation information has one or more confirmation items each of which involves a worker responsible for the confirmation, it is possible to accurately specify who is responsible for the cause due to which the first operation is not normally completed.

In the information processing method, in the determination as to whether the cause lies in the second operation, a confirmation item in connection with the cause may be specified on the basis of the confirmation result information, and the cause may be determined to lie in the second operation when the confirmation information shows that the specified confirmation item is associated with the second worker.

In this configuration, a confirmation item in connection with the cause due to which the first operation is not normally completed is specified, and the cause is determined to lie in the second worker when the confirmation information shows that the confirmation item is associated with the second worker. Thus, this enables accurately determining whether the second worker is responsible for the cause.

In the information processing method, the first operation may include one or more steps, and the completion of the first operation may include completion of one of the one or more steps of the first operation.

In this configuration, since the completion of the first operation includes completion of one of the steps of the first operation, it is possible to accurately determine where the cause due to which one step is not normally completed lies.

In the information processing method, in the detection of the first operation, state information indicative of progress of the first operation may be acquired, and the completion of the first operation may be detected on the basis of the state information.

This configuration enables detection of the completion of the first operation based on the state information indicative of the progress of the first operation.

In the information processing method, the state information may include sensing data of a sensor for detecting an operational situation of the first operation.

In this configuration, since the sensing data of the sensor for detecting the operational situation of the first operation serves as the state information, an accurate detection of the completion of the first operation can be obtained.

In the information processing method, the state information may include an input notice by the first worker as to the completion of the first operation.

In this configuration, since the input notice by the worker as to the completion of the first operation serves as the state information, an accurate detection of the completion of the first operation can be obtained.

In the information processing method, the first operation may be performed after completion of the second operation.

This configuration enables evaluation of the second worker in connection with the first operation performed after the completion of the second operation.

In the information processing method, the second operation may be an operation of placing a communication cable in a building, and the first operation may be an operation of connecting the communication cable to a device and connecting the device to a network.

This configuration enables evaluation of the second worker that performs the second operation of placing the communication in the building in connection with the first operation of connecting the communication cable to the device and connecting the device to the network.

An information processing apparatus according to another aspect of the present disclosure includes: an acquisition part for acquiring, when detecting completion of a first operation by a first worker, an evaluation value for the first worker; an output part for outputting on the basis of the evaluation value confirmation information of ordering the first worker to perform a confirmation as to whether the first operation is normally completed, the confirmation information including more confirmation items as the evaluation value is lower; a first determination part for determining on the basis of confirmation result information indicative of a result of the confirmation whether the first operation is normally completed; a second determination part for determining, when the first operation is determined to be not normally completed, on the basis of the confirmation result information whether a cause due to which the first operation is not normally completed lies in a second operation by a second worker different from the first operation; and an evaluation part for decreasing the evaluation value for the second worker when the cause is determined to lie in the second operation.

This configuration enables provision of an information processing apparatus that exerts the same advantageous effects as those described for the information processing method.

An information processing program according to another aspect of the present disclosure causes a processor of an information processing apparatus to execute processing of: acquiring, when detecting completion of a first operation by a first worker, an evaluation value for the first worker; outputting on the basis of the evaluation value confirmation information of ordering the first worker to perform a confirmation as to whether the first operation is normally completed, the confirmation information including more confirmation items as the evaluation value is lower; determining on the basis of confirmation result information indicative of a result of the confirmation whether the first operation is normally completed; determining, when the first operation is determined to be not normally completed, on the basis of the confirmation result information whether a cause due to which the first operation is not normally completed lies in a second operation by a second worker different from the first operation; and decreasing the evaluation value for the second worker when the cause is determined to lie in the second operation.

This configuration enables provision of an information processing program that exerts the same advantageous effects as those described for the information processing method.

The disclosure can be realized as an information processing system operated by the information processing program. Additionally, it goes without saying that the program is distributable as a non-transitory computer readable storage medium like a CD-ROM, or distributable via a communication network like the Internet.

Each of the embodiments which will be described below represents a specific example of the disclosure. Numerical values, shapes, constituent elements, steps, and the order thereof described below are mere examples, and thus should not be construed to delimit the disclosure. Further, constituent elements which are not recited in the independent claims each showing the broadest concept among the constituent elements in the embodiments are described as selectable constituent element. The respective contents are combinable with each other in all the embodiments.

### Embodiments

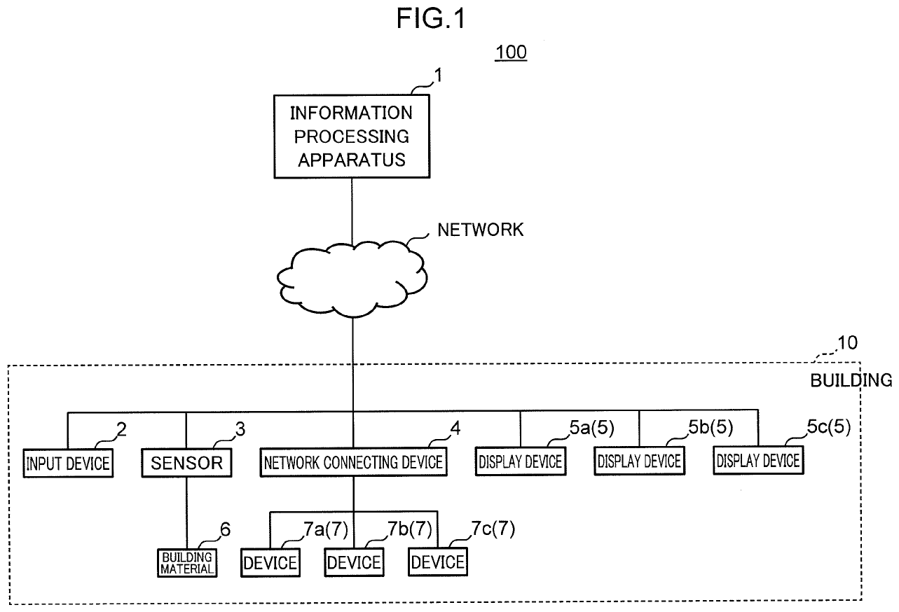

FIG. 1 is a block diagram showing an exemplary whole structure of an information processing system 100 according to an embodiment of the present disclosure. In FIG. 1, devices 7a, 7b, and 7c are generally called a device 7; and display devices 5a, 5b, and 5c are generally called a display device 5. The device 7 is an IoT device connectable to a network. The building 10 is, for example, a house, an office, a factory, a hospital, or a school. A case in which the building 10 is a detached house will be described below. The house is a detached one, or may be a multifamily residential (e.g., a condominium).

The information processing system 100 includes: an information processing apparatus 1; an input device 2; a sensor 3; a network connecting device 4; display devices 5a, 5b, and 5c; a building material 6; and devices 7a, 7b, and 7c. The information processing apparatus 1 is, for example, a cloud server including one or more computers. This is merely an example, and the information processing apparatus 1 may be an edge server installed in the building 10.

The network is, for example, a public line including a public telephone network, a mobile phone communication network, and the Internet.

The input device 2 to the device 7 are installed in the building 10. Each of the input device 2 to the device 7 is communicably connected with the information processing apparatus 1 through the network.

The input device 2 is, for example, a mobile terminal carried by a worker. The mobile terminal is, for example, a smartphone or a tablet computer. The input device 2 accepts various input notices from the worker for notifying the progress of the operation and transmits them to the information processing apparatus 1.

The sensor 3 includes, for example, an image sensor (camera), a temperature sensor, a humidity sensor, and a microphone, and is used for monitoring the operational situation for the worker. The sensor 3 acquires sensing data by sensing at a predetermined sampling period and transmits the acquired sensing data to the information processing apparatus 1 at the predetermined sampling period. The image sensor may be a wearable camera on the worker.

The network connecting device 4 is, for example, a modem, a router, a hub, an access point, or a gateway. The network connecting device 4 is used for connecting the device 7 to the network.

The display device 5 (an exemplary terminal) is a mobile terminal carried by a worker. The mobile terminal is, for example, a smartphone or a tablet computer. The display device 5 receives procedure information as to operational contents from the information processing apparatus 1 to show the received procedure information on the display, which enables a worker inexperienced in the operation to efficiently proceed with the operation by referring to the procedure information shown on the display.

For example, a worker to install a device 7a has the display device 5a, a worker to install a device 7b has the display device 5b, and a worker to install a device 7c has the display device 5c. The input device 2 and the display device 5 are separately shown in FIG. 1, but may be included in a single terminal. Input devices 2 may be included in respective terminals with the display devices 5a, 5b, and 5c carried by workers. For example, the display device 5a includes an input device 2 of the worker having the display device 5a, the display device 5b includes an input device 2 of the worker having the display device 5b, and the display device 5c includes an input device 2 of the worker having the display device 5c.

The building material 6 includes a material for building a house, e.g., an exterior wall, a window, a door, and a roof.

The device 7 is an IoT device connectable to the network through the network connecting device 4. The device 7 is, for example, an air conditioner, a television, a refrigerator, a washing machine, a microwave oven, a hot water dispenser, or an audio device.

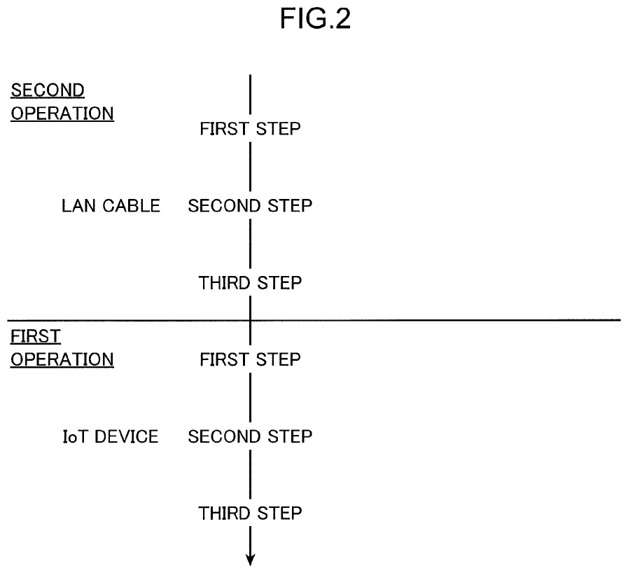

Next, exemplary operations in the present embodiment will be described. FIG. 2 is an illustration showing exemplary operations in the present embodiment. The exemplary operations include a second operation performed by a second worker and a first operation performed by a first worker after completion of the second operation. An exemplary second operation is a construction operation of preparing a communication network in the building 10. Thus, an exemplary second worker is one in a construction company that performs such a construction operation. An exemplary first operation is an operation of installing a network connecting device 4 or a device 7 in the building 10. Thus, a first worker is one in an installation company that performs an operation of installing a network connecting device 4 or a device 7.

The second operation includes, for example, three steps of a first step, a second step, and a third step. In the first step of the second operation, for example, an uncut LAN cable is cut in an appropriate length and a LAN connector is connected to the end of the cut LAN cable, thereby a LAN cable is prepared. In the second step of the second operation, for example, the LAN cable is placed in a wall of the building 10 and the placed LAN cable is connected to an optical network unit of a phone company. In the third step of the second operation, for example, a hole is formed through the wall of the building 10, the placed LAN cable is drawn out through the hole, and connected to a LAN outlet, and the LAN outlet is embedded in the wall.

The first operation includes, for example, three steps of a first step, a second step, and a third step. In the first step of the first operation, for example, a network connecting device 4 or a device 7 is installed in the building 10 and a power cable is connected to a power outlet. In the second step of the first operation, for example, the network connecting device 4 is connected to the LAN outlet via the LAN cable or the device 7 is connected to the network connecting device 4 via the LAN cable. In the third step, for example, settings required to connect the network connecting device 4 or the device 7 to the network are input.

The operations shown in FIG. 2 are merely examples, and there may be other operations for the present disclosure. For example, the second operation may be an operation of installing the network connecting device 4 or the device 7 and physically connecting the network connecting device 4 or the device 7 to the network via the LAN cable; and the first operation may be an operation of inputting, to the network connecting device 4 or the device 7, settings for logically connecting the physically connected network connecting device 4 or device 7 to the network.

In the example shown in FIG. 2, there are two operations, i.e., the first operation and the second operation, but the present disclosure is not limited to this and there may be three or more operations in which the second operation may include a plurality of tasks each of which is performed by a plurality of different workers. With respect to the second operation, for convenience of explanation, a case in which one second operation is performed by one second worker will be described below. The one second operation is not necessarily performed by the one second worker, and may be performed by a plurality of workers (e.g., workers in the same company or group) cooperatively.

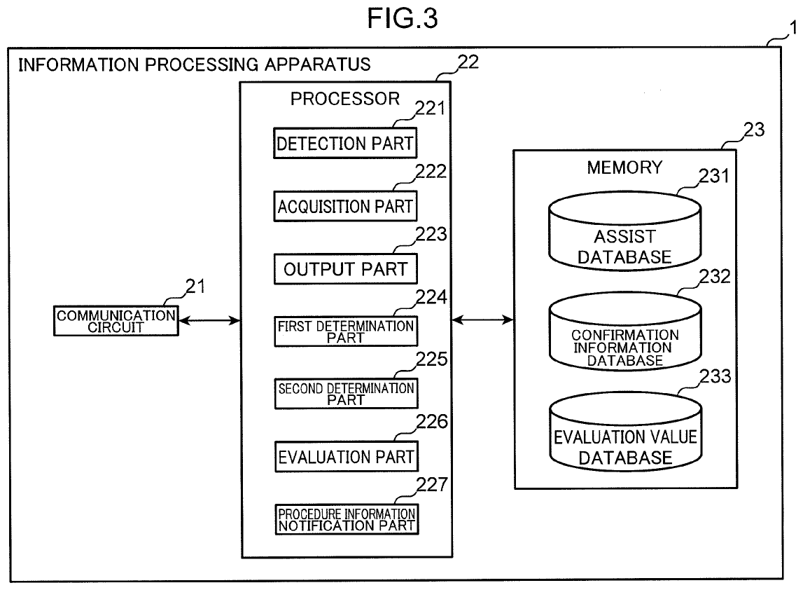

FIG. 3 is a block diagram showing an exemplary structure of an information processing apparatus 1 according to the embodiment of the present disclosure. The information processing apparatus 1 includes a communication circuit 21, a processor 22, and a memory 23. The communication circuit 21 connects the information processing apparatus 1 to the network. The communication circuit 21 receives sensing data transmitted from the sensor 3 at a predetermined sampling period. The communication circuit 21 receives from the input device 2 an input notice that the input device 2 has taken from a worker. The communication circuit 21 transmits procedure information for assisting an operation by a worker to the display device 5. The communication circuit 21 transmits to the display device 5 confirmation information, which will be described later. The communication circuit 21 receives from the input device 2 confirmation result information, which will be described later.

The processor 22 has, for example, a central processing unit and includes a detection part 221, an acquisition part 222, an output part 223, a first determination part 224, a second determination part 225, an evaluation part 226, and a procedure information notification part 227. The detection part 221 to the procedure information notification part 227 do performance when the central processing unit executes an information processing program. However, this configuration is merely an example, and the detection part 221 to the procedure information notification part 227 may be constituted by dedicated hardware, e.g., an ASIC.

The detection part 221 detects whether the first operation by the first worker is completed. For example, the detection part 221 acquires state information indicative of progress of the first operation and detects whether the first operation is completed on the basis of the acquired state information.

The state information is sensing data acquired by the sensor 3, or may be an input notice as to the completion of the first operation that is input by the first worker through the input device 2.

For example, in the case that the state information is the sensing data, the detection part 221 detects whether the first operation is completed by performing pattern matching of comparing the data of an image captured by the image sensor with a template image that is stored in the memory 23 in advance and is indicative of the completion of the first operation. The template image includes, for example, a captured image of a state in which cables such as a LAN cable and a power cable are accurately connected onto a back face of the network connecting device 4.

For example, in the case that the state information is the input notice, the detection part 221 determines that the first operation is completed when the communication circuit 21 receives the input notice transmitted from the input device 2.

Although only the exemplary case in which the detection part 221 detects whether the first operation is completed is described, the detection part 221 detects whether the second operation is completed. Since the steps of the process of detecting whether the second operation is completed are the same as the steps of the process of detecting whether the first operation is completed, the description thereof will be omitted.

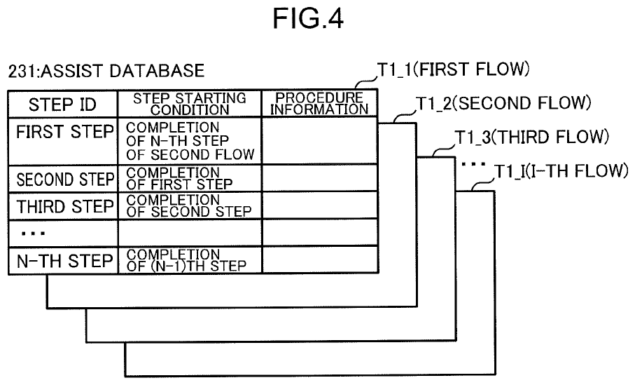

The detection part 221 may further detect to which step the first operation is progressed on the basis of the state information. For example, the detection part 221 refers to the table T1_1 (FIG. 4) that is stored in the assist database 231 and corresponds to the first operation and determines on the basis of the state information whether a step starting condition for one step is satisfied. The first operation is determined to be progressed to the one step when the step starting condition for the one step is determined to be satisfied. Since the step starting condition for the one step is completion of the previous step thereof, the detection part 221 determines that the step starting condition for the one step is satisfied when detecting the completion of the previous step thereof. The process of detecting whether the previous step is completed is as follows.

For example, the detection part 221 determines that the previous step is completed, when the communication circuit 21 receives an input notice as to the completion of the previous step after a worker inputs the input notice through the input device 2.

Alternatively, the detection part 221 may detect whether the previous step is completed by performing pattern matching of comparing an image of the operation by the first worker captured by the image sensor with a template image that is stored in the memory 23 in advance and is indicative of the completion of the previous step.

The detection part 221 may determine whether the previous step is completed on the basis of a change in the temperature or humidity detected by the temperature sensor or humidity sensor. For example, in the case that the previous step is an operation of forming a hole through an external wall, the temperature or humidity in the building 10 changes by a certain degree or more due to the hole passing therethrough. Therefore, the detection part 221 can determine that the previous step is completed when the temperature or humidity detected by the temperature sensor or humidity sensor provided in the building 10 changes by the certain degree or more.

The detection part 221 may determine whether the previous step is completed on the basis of sound data of the sound picked up by the microphone. For example, a specific sound occurs when a cutout of the external wall falls onto the ground after a hole is formed through the external wall. Thus, the detection part 221 can determine whether the previous step is completed by performing pattern matching of comparing the sound data of the sound picked up by the microphone with data of the specific sound.

The detection part 221 can detect whether each step of the second operation is completed by using the same process as that for the first operation.

The acquisition part 222 acquires an evaluation value for the first worker from an evaluation value database 233 in the memory 23 when the detection part 221 detects the completion of the first operation. The acquisition part 222 can acquire an evaluation value for the second worker from the evaluation value database 233.

The output part 223 generates on the basis of the evaluation value acquired by the acquisition part 222 confirmation information of ordering the first worker to perform a confirmation as to whether the first operation is normally completed, and outputs the generated confirmation information to the display device 5 of the first worker through the communication circuit 21. In this regard, the output part 223 generates the confirmation information such that the confirmation information includes more confirmation items as the evaluation value is lower. Thus, an additional confirmation is imposed on a worker with a low evaluation value. The additional confirmation, which increases the operational burden on the worker, serves as a penalty. In the generation of the confirmation information, the output part 223 can refer to a confirmation information database 232.

The first determination part 224 acquires confirmation result information indicative of a result of the confirmation by the first worker through the communication circuit 21, and determines on the basis of the acquired confirmation result information whether the first operation is normally completed. For example, the confirmation result information is generated by the input device 2 on the basis of the result of the confirmation input by the first worker to the input device 2 and transmitted from the input device 2 to the information processing apparatus 1. The confirmation result information includes a result of a confirmation for each confirmation item. The result of the confirmation indicates the normality or the abnormality.

The second determination part 225 determines, when the first determination part 224 determines that the first operation is not normally completed, on the basis of the confirmation result information whether a cause due to which the first operation is not normally completed lies in the second operation. In this regard, the confirmation information has one or more confirmation items each of which is associated with a worker responsible for the confirmation in advance. Thus, the second determination part 225 specifies a confirmation item in connection with the cause on the basis of the confirmation result information, refers to the confirmation information, and determines that the cause due to which the first operation is not normally completed lies in the second operation when the confirmation information shows that the specified confirmation item is associated with the second worker.

The evaluation part 226 decreases the evaluation value for the second worker when the second determination part 225 determines that the cause due to which the first operation is not normally completed lies in the second operation. For example, the evaluation part 226 decreases the current evaluation value for the second worker by a predetermined value to obtain a decreased evaluation value. The evaluation part 226 may decrease the evaluation value for the second worker when the number of continuous determinations that the cause due to which the first operation is not normally completed lies in the second worker reaches a predetermined number. Although an example in which the evaluation value for the second worker is decreased is given, the evaluation value for the first worker is decreased according to a result of a confirmation for another operation performed after the completion of the first operation.

The procedure information notification part 227 outputs, when the detection part 221 determines that the step starting condition for one step is satisfied, procedure information as to operational contents of the one step to the display device 5 of the first worker through the communication circuit 21. Since the procedure information is displayed on the display of the display device 5, even a worker inexperienced in the operation can proceed with the operation while checking the procedure information and without making any mistakes.

The memory 23 includes a storage device that is non-volatile and rewritable, e.g., a hard disk drive or a solid state derive, and stores the assist database 231, the confirmation information database 232, and the evaluation value database 233.

In the assist database 231, assist information for assisting a plurality of operations (including the first operation and the second operation) managed by the information processing apparatus 1 is stored. FIG. 4 is a table showing exemplary data components in an assist database 231.

The assist database 231 includes a table T1_i corresponding to an i-th (i: an integer from 1 to I) flow indicative of an operational procedure of an i-th operation. The table T1_i is exemplary assist information.

The table T1_i includes a step ID, a step starting condition, and procedure information. The step ID serves as an identifier for each step. The step starting condition is a condition for starting each step. For example, the first flow cannot be started unless the second flow is completed. Therefore, in the table T1_1, the starting condition for the first step includes “COMPLETION OF N-TH STEP OF SECOND FLOW”, which indicates the completion of the final step of the second flow.

For example, in the table T1_1, since the N-th step is a step in the N-th place, the step starting condition for the N-th step includes “COMPLETION OF (N-1)TH STEP” which indicates the completion of the (N-1)th step of the first flow. N is a variable indicative of the number of steps in each flow, and is an integer not less than two.

The procedure information indicates the operational contents displayed on the display device 5 in each step. The procedure information is information specifically showing the worker the operational contents in each step of each flow with an illustration and the like. Tables T1_2 to T1_1 other than the table T1_1 include assist information according to contents of a flow like the table T1_1.

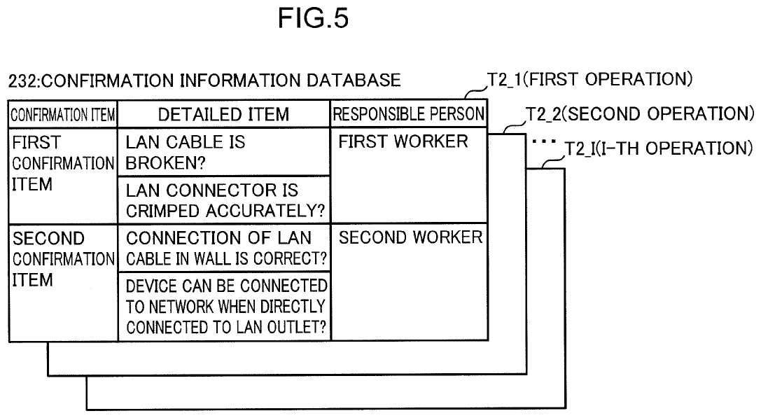

FIG. 5 is a table showing exemplary data components in a confirmation information database 232. The confirmation information database 232 includes a table T2_i (i: 1 to N) as to the confirmation for the i-th operation.

The table T2_i includes a confirmation item, a detailed item, and a responsible person. The confirmation item includes a first confirmation item and a second confirmation item. The first confirmation item represents, for example, a confirmation that can be done by the first worker's visual checking. The second confirmation item represents a confirmation for which a dedicated device or application is required. The dedicated device or application for the confirmation includes, for example, a LAN tester, an ammeter, and a voltmeter.

The detailed item shows specific contents of a confirmation. In FIG. 5, the first confirmation item includes two detailed items of “LAN CABLE IS BROKEN?” and “LAN CONNECTOR IS CRIMPED ACCURATELY?”. The second confirmation item includes two detailed items of “CONNECTION OF LAN CABLE IN WALL IS CORRECT?” and “DEVICE CAN BE CONNECTED TO NETWORK WHEN DIRECTLY CONNECTED TO LAN OUTLET?”.

The detailed item of “LAN CABLE IS BROKEN?” represents an operation of checking whether the LAN cable prepared by the first worker is broken. Thus, the first worker visually checks whether the LAN cable is broken. The detailed item of “LAN CONNECTOR IS CRIMPED ACCURATELY?” represents an operation of the first worker visually checking whether the LAN connector is crimped accurately to the end of the LAN cable prepared by the first worker.

The detailed item of “CONNECTION OF LAN CABLE IN WALL IS CORRECT?” represents an operation of checking whether the physical connection of the LAN cable placed in the wall is established. The operation is performed with a dedicated device or application, e.g., a LAN tester. The detailed item of “DEVICE CAN BE CONNECTED TO NETWORK WHEN DIRECTLY CONNECTED TO LAN OUTLET?” represents an operation of checking whether the LAN cable in the wall is connected to the network. The operation is performed by directly connecting the network connecting device 4 or the device 7 to the LAN outlet via the LAN cable and inputting a command such as PING to the network connecting device 4 or the device 7.

The responsible person represents a person responsible for a confirmation item. In FIG. 5, the responsible person for the first confirmation item is the first worker, and the responsible person for the second confirmation item is the second worker.

Since the first operation is an operation of installing the network connecting device 4 or the device 7, the table T2_1 in FIG. 5 has a confirmation item set in accordance with the installation operation. This is merely an example, and the contents of a confirmation item can be changed according to an operation. In FIG. 5, the confirmation item is divided into the two of the first confirmation item and the second confirmation item, but may not be divided as such. In this case, the responsible person is set for each detailed item shown in the table T2_i. In FIG. 5, each of the first confirmation item and the second confirmation item includes two detailed items, but may include three or more detailed items or only one detailed item.

Reference is back to FIG. 3. In the evaluation value database 233, the respective current evaluation values for the first worker and the second worker are stored.

The assist database 231 to the evaluation value database 233, which are stored in the memory 23, may be stored in an external server provided outside the information processing apparatus 1. In this case, the information processing apparatus 1 can refer to the assist database 231 to the evaluation value database 233 by accessing the external server.

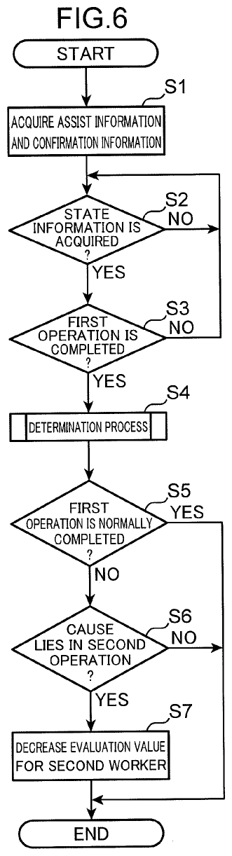

The configuration of the information processing apparatus 1 is as described above. Next, the process by the information processing apparatus 1 will be described. FIG. 6 is a flowchart showing an exemplary process of the information processing apparatus 1 according to the embodiment of the present disclosure. An exemplary case in which the flowchart is used for the first worker will be described below. The flowchart is also used for the second worker.

Step S1
The detection part 221 acquires assist information corresponding to the first operation from the assist database 231 and confirmation information corresponding to the first operation from the confirmation information database 232. The table T1_1 is acquired as the assist information and the table T2_1 is acquired as the confirmation information. In the case that the flowchart shown in FIG. 6 is used for the second operation, the table T1_2 and the table T2_2 are acquired.

Step S2
The detection part 221 acquires state information through the communication circuit 21. In the case that the state information is acquired (YES in Step S2), the process proceeds to Step S3; in the case that the state information is not acquired (NO in Step S2), the process stands by at Step S2.

Step S3
The detection part 221 detects on the basis of the acquired state information whether the first operation is completed. In the case that the completion of the first operation is detected (YES in Step S3), the process proceeds to Step S4; in the case that the completion of the first operation is not detected (NO in Step S3), the process returns to Step S2.

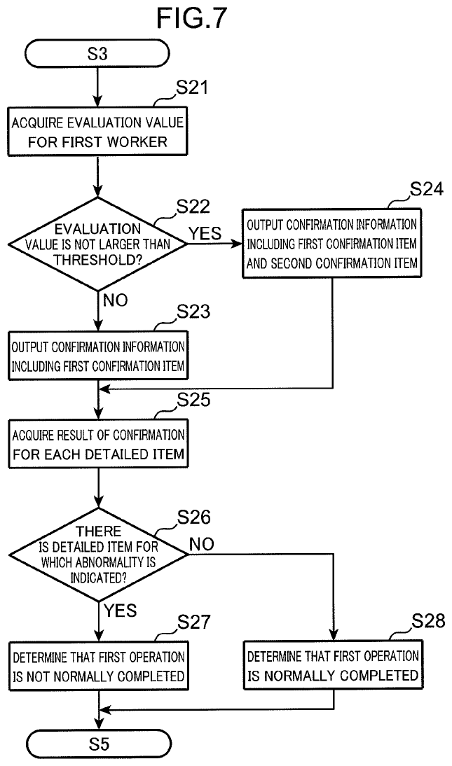

Step S4
A determination process of determining whether the first operation is normally completed is executed. The determination process will be described later with reference to FIG. 7.

Step S5
The first determination part 224 determines on the basis of the result of the determination process whether the first operation is normally completed. In the case that the first operation is not normally completed (NO in Step S5), the process proceeds to Step S6; in the case that the first operation is normally completed (YES in Step S5), the process ends.

Step S6
The second determination part 225 determines whether the cause due to which the first operation is not normally completed lies in the second operation. In the case that the cause lies in the second operation (YES in Step S6), the process proceeds to Step S7; in the case that the cause does not lie in the second operation, i.e., the cause lies in the first operation (NO in Step S6), the process ends. The second determination part 225 determines that the cause lies in the first operation when a result of the confirmation for a detailed item of the first confirmation item indicates the abnormality; and determines that the cause lies in the second operation when a result of the confirmation for a detailed item of the second confirmation item indicates the abnormality. The second determination part 225 determines “YES” in Step S6 when a result of the confirmation for a detailed item of the first confirmation item indicates the abnormality and a result of the confirmation for a detailed item of the second confirmation item indicates the abnormality.

Step S7
The evaluation part 226 decreases the evaluation value for the second worker. An additional confirmation is imposed on the second worker when the second worker performs the second operation thereafter.

FIG. 7 is a flowchart showing steps of a determination process in Step S4 shown in FIG. 6.

Step S21
The acquisition part 222 acquires the evaluation value for the first worker from the evaluation value database 233.

Step S22
The output part 223 determines whether the evaluation value acquired in Step S21 is not larger than a threshold. In the case that the evaluation value is not larger than the threshold (YES in Step S22), the process proceeds to Step S24; in the case that the evaluation value is larger than the threshold (NO in Step S22), the process proceeds to Step S23.

Step S23
The output part 223 generates confirmation information including the first confirmation item among the confirmation items set in the table T2_1 acquired in Step S1 and outputs the generated confirmation information to the display device 5 of the first worker through the communication circuit 21. Thus, the first confirmation item is displayed on the display device 5 of the first worker and the first worker performs the confirmation with reference to the displayed first confirmation item.

Step S24
The output part 223 acquires from the confirmation information database 232 the table T2_1 including the confirmation corresponding to the first operation, generates confirmation information including the first confirmation item and the second confirmation item among the confirmation items set in the table T2_1, and outputs the generated confirmation information to the display device 5 of the first worker through the communication circuit 21. Thus, the first confirmation item and the second confirmation item are displayed on the display device 5 of the first worker and the first worker performs the confirmation with reference to the displayed first confirmation item and second confirmation item. Accordingly, in Step S24, in the case that the evaluation value for the first worker is not larger than the threshold, the additional confirmation of the second confirmation item in addition to the first confirmation item is imposed. Thus, provision of the configuration of imposing an additional confirmation on a first worker with a low evaluation value can be achieved.

In the case that the flowchart in FIG. 7 is used for the second worker, when the evaluation value for the second worker is not larger than the threshold, a confirmation of the second confirmation item in addition to the first confirmation item is imposed on the second worker. Thus, provision of the configuration of imposing an additional confirmation on the second worker can be achieved.

Step S25
The first determination part 224 acquires confirmation result information indicative of a result of the confirmation by the first worker through the communication circuit 21. For example, a first worker on which only the first confirmation item is imposed inputs to the input device 2 the result of the confirmation for each detailed item of the first confirmation item that indicates the normality or the abnormality, and transmits the confirmation result information including the input results of the confirmation from the input device 2 to the information processing apparatus 1. For example, a first worker on which the second confirmation item in addition to the first confirmation item is imposed inputs to the input device 2 the result of the confirmation for each detailed item of the first confirmation item and the second confirmation item that indicates the normality or the abnormality, and transmits the confirmation result information including the input results of the confirmation from the input device 2 to the information processing apparatus 1.

Step S26
The first determination part 224 determines whether there is a detailed item for which the confirmation result information acquired in Step S25 indicates the abnormality. In the case that there are no detailed items for which the abnormality is indicated (NO in step S26), the process proceeds to Step S28; in the case that there is a detailed item for which the abnormality is indicated (YES in Step S26), the process proceeds to Step S27.

Step S27
Since there is a detailed item for which the confirmation result information indicates the abnormality, the first determination part 224 determines that the first operation is not normally completed.

Step S28
Since there are no detailed items for which the confirmation result information indicates the abnormality, the first determination part 224 determines that the first operation is normally completed.

When the process in Step S27 or Step S28 ends, the process proceeds to Step S5 in FIG. 6.

Thus, according to the embodiment, in the case that the first operation is not normally completed, it is determined on the basis of the confirmation result information indicative of the result of the confirmation as to the first operation whether the cause due to which the first operation is not normally completed lies in the second operation by the second worker, and, when the cause is determined to lie in the second operation, the evaluation value for the second worker is decreased. This makes the second worker have more confirmation items when the second worker performs the operation next time. Thus, provision of the configuration of imposing an additional confirmation on a worker that has performed an imperfect operation can be achieved.

In the present disclosure, the following modifications may be implemented.

(1) In the embodiment described above, the generated confirmation information includes the second confirmation item in addition to the first confirmation item in the case that the evaluation value is not larger than the threshold, to which the present disclosure is not limited; and the generated confirmation information may include more confirmation items as the evaluation value is lower.

(2) In the present disclosure, “the completion of the first operation” does not necessarily mean the completion of all of the steps of the first operation, and may mean completion of one step of the first operation. In this case, the information processing apparatus 1 can output the confirmation information to the display device 5 of the first worker when one step of the first operation is completed.

The present disclosure is useful for smoothly performing an operation of installing a device in a building.

1. An information processing method, by a processor of an information processing apparatus, comprising:
acquiring, when detecting completion of a first operation by a first worker, an evaluation value for the first worker;
outputting on the basis of the evaluation value confirmation information of ordering the first worker to perform a confirmation as to whether the first operation is normally completed, the confirmation information including more confirmation items as the evaluation value is lower;
determining on the basis of confirmation result information indicative of a result of the confirmation whether the first operation is normally completed;
determining, when the first operation is determined to be not normally completed, on the basis of the confirmation result information whether a cause due to which the first operation is not normally completed lies in a second operation by a second worker different from the first operation; and
decreasing the evaluation value for the second worker when the cause is determined to lie in the second operation.

2. The information processing method according to claim 1, wherein
the confirmation information has one or more confirmation items each of which is associated with a worker responsible for the confirmation in advance.

3. The information processing method according to claim 2, wherein
in the determination as to whether the cause lies in the second operation, a confirmation item in connection with the cause is specified on the basis of the confirmation result information, and the cause is determined to lie in the second operation when the confirmation information shows that the specified confirmation item is associated with the second worker.

4. The information processing method according to claim 1, wherein
the first operation includes one or more steps, and
the completion of the first operation includes completion of one of the one or more steps of the first operation.

5. The information processing method according to claim 1, wherein
in the detection of the first operation, state information indicative of progress of the first operation is acquired, and the completion of the first operation is detected on the basis of the state information.

6. The information processing method according to claim 5, wherein the state information includes sensing data of a sensor for detecting an operational situation of the first operation.

7. The information processing method according to claim 5, wherein
the state information includes an input notice by the first worker as to the completion of the first operation.

8. The information processing method according to claim 1, wherein the first operation is performed after completion of the second operation.

9. The information processing method according to claim 1, wherein
the second operation is an operation of placing a communication cable in a building, and the first operation is an operation of connecting the communication cable to a device and connecting the device to a network.

10. An information processing apparatus comprising:
an acquisition part for acquiring, when detecting completion of a first operation by a first worker, an evaluation value for the first worker;
an output part for outputting on the basis of the evaluation value confirmation information of ordering the first worker to perform a confirmation as to whether the first operation is normally completed, the confirmation information including more confirmation items as the evaluation value is lower;
a first determination part for determining on the basis of confirmation result information indicative of a result of the confirmation whether the first operation is normally completed;
a second determination part for determining, when the first operation is determined to be not normally completed, on the basis of the confirmation result information whether a cause due to which the first operation is not normally completed lies in a second operation by a second worker different from the first operation; and
an evaluation part for decreasing the evaluation value for the second worker when the cause is determined to lie in the second operation.

11. A non-transitory computer readable recording medium storing an information processing program causing a processor of an information processing apparatus to execute processing of:
acquiring, when detecting completion of a first operation by a first worker, an evaluation value for the first worker;
outputting on the basis of the evaluation value confirmation information of ordering the first worker to perform a confirmation as to whether the first operation is normally completed, the confirmation information including more confirmation items as the evaluation value is lower;
determining on the basis of confirmation result information indicative of a result of the confirmation whether the first operation is normally completed;
determining, when the first operation is determined to be not normally completed, on the basis of the confirmation result information whether a cause due to which the first operation is not normally completed lies in a second operation by a second worker different from the first operation; and
decreasing the evaluation value for the second worker when the cause is determined to lie in the second operation.
